(19) United States
(12) Patent Application Publication
(10) Pub. No.: US 2025/0093815 A1
(43) Pub. Date: Mar. 20, 2025

(54) CONTINUOUS HOLOGRAM RECORDING METHOD

(71) Applicant: Korea Electronics Technology Institute, Seongnam-si (KR)

(72) Inventors: Sung Hee HONG, Seoul (KR); Young Min KIM, Seoul (KR); Ji Soo HONG, Seoul (KR)

(73) Assignee: Korea Electronics Technology Institute, Seongnam-si (KR)

(21) Appl. No.: 18/713,785

(22) PCT Filed: Dec. 6, 2021
(86) PCT No.: PCT/KR2021/018320

§ 371 Date: Dec. 6, 2024

(30) Foreign Application Priority Data
Dec. 6, 2021 (KR) 10-2021-0172559

(51) Int. Cl. G03H 1/04

(52) U.S. Cl. CPC G03H 1/0476; G03H 2001/048; G03H 2227/05

(57) ABSTRACT

A continuous hologram recording method is provided. A holographic printer according to an embodiment of the present invention comprises: a light source that emits light; a modulator that modulates the light emitted from the light source, to generate a holographic fringe pattern in units of hogels; a stage having placed thereon a hologram recording medium on which a holographic fringe pattern generated by the modulator is to be recorded in units of hogels; a first driving unit that moves the position of the stage in a first axial direction by using a first-type motor; and a second driving unit that moves the position of the stage in a second axial direction by using a second-type motor different from the first type. Accordingly, continuous hologram recording is enabled by appropriately implementing a motor that moves the stage on which the hologram recording medium is placed, according to vibration characteristics, thereby remarkably reducing the printing time for large holograms, which used to take several days to tens of days, and thus accelerating the commercialization of hologram printing.

### TECHNICAL FIELD

The disclosure relates to a hologram recording method, and more particularly, to a method of continuously recording a hologram on a hologram recording medium on a hogel basis by using a holographic printer.

### BACKGROUND ART

FIG. 1 is a view illustrating a hologram recording process of a holographic printer. A hologram may be recorded in the unit of a hogel, which is a part obtained by dividing a hologram in a grid pattern. A hogel of a hologram may be understood as a concept corresponding to a pixel of an image.

The process illustrated in FIG. 1 is a process of recording one hogel. As shown in the drawing, a stage on which a hologram recording medium, on which a hologram is to be recorded, is placed may be moved and stopped, and then, a hologram image of a corresponding hogel may be uploaded and a hologram corresponding to the hogel may be recorded on the hologram recording medium by operating (opening)/stopping (closing) a shutter.

In this process, a step motor used for moving the stage may cause a very great vibration when moving. However, a holographic printer may be vulnerable to a vibration and thus should record a hogel after waiting until the stage is moved and is completely stopped.

To this end, when a large-scale hologram is recorded, it may take several days to tens of days to process the hologram, which may become a major obstacle to commercialization of hologram printing.

### DISCLOSURE

### Technical Problem

The disclosure has been developed in order to address the above-discussed deficiencies of the prior art, and an object of the disclosure is to provide a holographic printer in which a motor for moving a stage on which a hologram recording medium is placed is appropriately implemented according to vibration characteristics, and a continuous hologram recording method using the same, as a solution to enhance a printing speed of a large-scale hologram, which takes several days to tens of days.

### Technical Solution

According to an embodiment of the disclosure to achieve the above-described object, a holographic printer may include: a light source configured to emit light; a modulator configured to generate a holographic fringe pattern on a hogel basis by modulating light emitted from the light source; a stage on which a hologram recording medium is placed, the holographic fringe pattern generated by the modulator being recorded on the hologram recording medium on a hogel basis; a first driver configured to move a position of the stage in a first axis direction by using a motor of a first type; a second driver configured to move the position of the stage in a second axis direction by using a motor of a second type which is different from the first type.

The first axis direction may be an X-axis direction, and the second axis direction may be a Y-axis direction.

When the second driver moves the stage by one step in the Y-axis direction, the first driver may continuously move the stage from beginning to end in the X-axis direction.

A length of one step by which the stage is moved by the second driver may correspond to a vertical axis length of a hogel, and a length by which the stage is continuously moved by the first driver may correspond to a length of a horizontal line of a hologram.

The motor of the first type may be a motor that produces low vibration in a moving state, and the motor of the second type may be a motor that produces low vibration in a stationary state.

The motor of the first type may be a servo motor, and the motor of the second type may be a step motor.

The first driver may change a moving direction of the stage to the opposite direction on the first axis every time the position of the stage is controlled by the second driver.

According to another embodiment of the disclosure, a hologram recording method may include: a step of emitting light; a step of generating a holographic fringe pattern on a hogel basis by modulating emitted light; a step of moving a position of a stage on which a hologram recording medium, on which the generated holographic fringe pattern is to be recorded on a hogel basis, is placed in a second axis direction by using a motor of a second type; and a step of moving the position of the stage in a first axis direction by using a motor of a first type which is different from the second type.

### Advantageous Effects

As described above, according to embodiments of the disclosure, a motor for moving a stage on which a hologram recording medium is placed may be appropriately implemented according to vibration characteristics, so that continuous hologram recording is possible and large-scale hologram printing time, which taken several days to tens of days, may be remarkably reduced, and commercialization of hologram printing may be accelerated.

### DESCRIPTION OF DRAWINGS

FIG. 1 is a view illustrating a hologram recording process of a holographic printer;

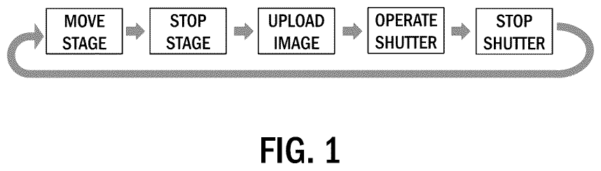

FIG. 2 is a view illustrating a structure of a holographic printer according to an embodiment of the disclosure;

FIG. 3 is a view provided to explain a method of moving a stage by an X-driver and a Y-driver;

FIG. 4 is a timing chart for controlling opening of a shutter in the middle of moving the stage in an X-axis direction by the X-driver; and

FIG. 5 is a flowchart provided to explain a continuous hologram recording method according to another embodiment of the disclosure.

### BEST MODE

Hereinafter, the disclosure will be described in more detail with reference to the drawings.

Embodiments of the disclosure provide a continuous hologram recording method. Specifically, the disclosure adopts a method of implementing a motor for operating a stage on which a hologram recording medium, on which a hologram is to be recorded on a hogel basis, is placed in an X-axis direction, by a servo motor which causes less vibration when moving, rather than by a step motor.

Through this, hogel recording is continuously performed with respect to a horizontal line without stopping a stage, so that a printing speed may be remarkably enhanced.

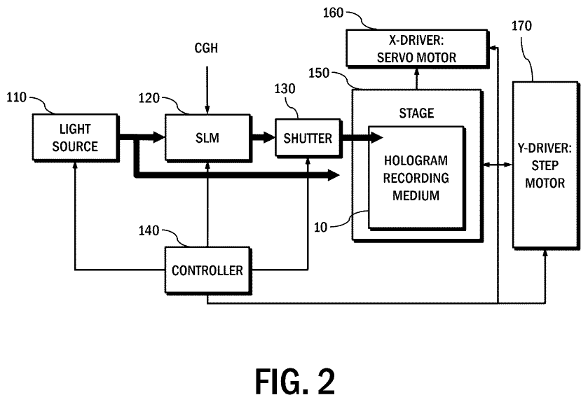

FIG. 2 is a view illustrating a structure of a holographic printer according to an embodiment of the disclosure. The holographic printer according to an embodiment of the disclosure may include a light source 110, a spatial light modulator (SLM) 120, a shutter 130, a controller 140, a stage 150, an X-driver 160 and a Y-driver 170 as shown in the drawing.

The light source 110 emits light which is used for generating object light and reference light required to generate a hologram. The light source 110 may be implemented by a laser light source.

Light emitted from the light source 110 may be split by a beam splitter (not shown), such that a part of the light is applied to the SLM 120 and the other part of the light enters a hologram recording medium 10 through an optical system as reference light.

The SLM 120 may generate a holographic fringe pattern by modulating light entering from the light source 110, based on a computer generated hologram (CGH) generated by a hologram generation system (not shown) which is a computing system.

The holographic fringe pattern is generated at the SLM 120 on a hogel basis. Accordingly, a CGH image may be generated at the hologram generation system on a hogel basis and may be applied to the SLM 120 on a hogel basis.

The shutter 130 may periodically be opened and closed to periodically expose the holographic fringe pattern generated at the SLM 120 to the hologram recording medium 10. While the shutter 130 is open, a hologram which is an interference fringe of object light generated by the holographic fringe pattern and reference light generated by a part of light split from the light source 110 may be recorded on a corresponding hogel area of the hologram recording medium 10.

The hologram recording medium 10 may be placed on the stage 150, and the X-driver 160 and the Y-driver 170 may move the stage 150 in X-axis and Y-axis directions to allow a hologram to be recorded on the hologram recording medium 10 on a hogel basis.

The controller 140 may control turning on/off of the light source 110, a modulating operation of the SLM 120, a timing and a speed of the shutter 130, and movement of the stage 150 by the X-driver 160 and the Y-driver 170.

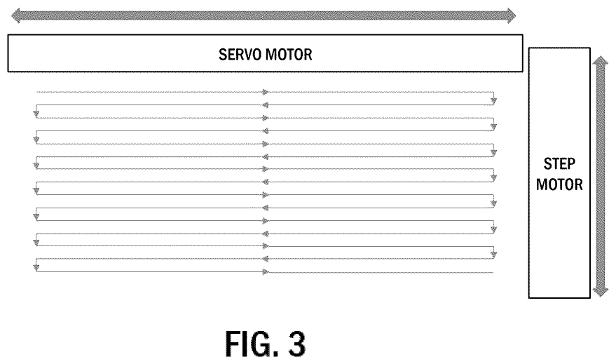

FIG. 3 is a view provided to explain a method of moving the stage 150 by the X-driver 160 and the Y-driver 170.

As shown in the drawing, the X-driver 160 is configured to continuously move the position of the stage 150 in the X-axis direction by using a servo motor, and the Y-driver 170 is configured to intermittently move the position of the stage 150 in the Y-axis direction by using a step motor.

In FIG. 3, the arrow directions are directions in which the stage 150 moves, that is, directions in which the position of the stage 150 is changed. As shown in the drawing, the stage 150 may be moved downwardly by one step by the Y-driver 170, and then, may be continuously moved in the rightward direction from beginning to end by the X-driver 160. A length of one step by which the stage 150 is moved by the Y-driver 170 may correspond to a vertical-axis length of a hogel.

Then, the stage 150 may be moved downwardly by one step by the Y-driver 170, and then, may be continuously moved in the leftward direction from beginning to end by the X-driver 160. A length by which the stage 150 is continuously moved by the X-driver 160 may correspond to a length of a horizontal line of a hologram to be recorded.

Accordingly, the stage 150 may be moved in a zig-zag pattern by the X-driver 160 and the Y-driver 170.

As can be seen through FIG. 3, the Y-driver 170 may be in a stationary state for longer time than in a moving state, and thus may be implemented by a step motor that may produce lots of vibration in a moving state, but may produce low vibration in a stationary state.

In addition, the X-driver 160 may be in a moving state for longer time than in a stationary state, and thus may be implemented by a servo motor that may produce lots of vibration in a stationary state but may produce low vibration in a moving state. The servo motor may minutely vibrate to maintain a posture/position in a stationary state, producing lots of vibration in the stationary state.

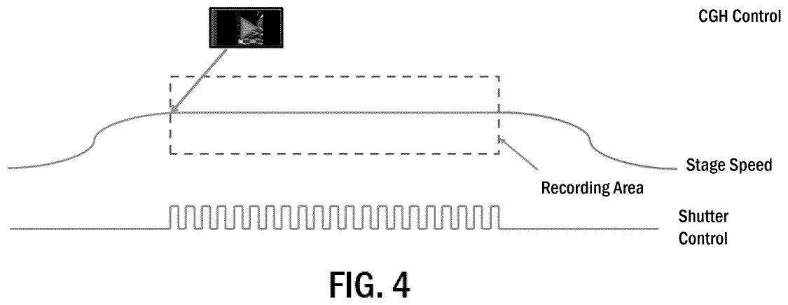

FIG. 4 illustrates a timing chart for controlling opening of the shutter 130 in the middle of moving the stage 150 in the X axis direction by the X-driver 160.

When the stage 150 is moved downwardly by one step by the Y-driver 170 and then the Y-driver 170 enters a stationary state, the SLM 120 may generate a fringe pattern of a corresponding hogel, and the X-driver 160 may continuously move the stage 150 in the X-axis direction as shown in FIG. 4.

As shown in FIG. 4, in a section where a moving speed of the stage 150 moved by the X-driver 160 reaches a uniform velocity, a holographic fringe pattern may be generated by the SLM 120 and the shutter 130 may be opened.

The moving speed of the stage 150 moved by the X-driver 160 may be determined by a CGH image frame rate and a horizontal length of a hogel. For example, if the CGH frame rate is 20 frames per second and the horizontal length of the hogel is 0.5 mm, the moving speed of the stage 150 in the X axis direction should be 10 mm/s.

In addition, an exposure time of the shutter 130 may be adjusted according to a duty cycle of a shutter clock. If an exposure time in a CGH image having 20 frames per second should be 5 msec, the duty cycle may be 10%.

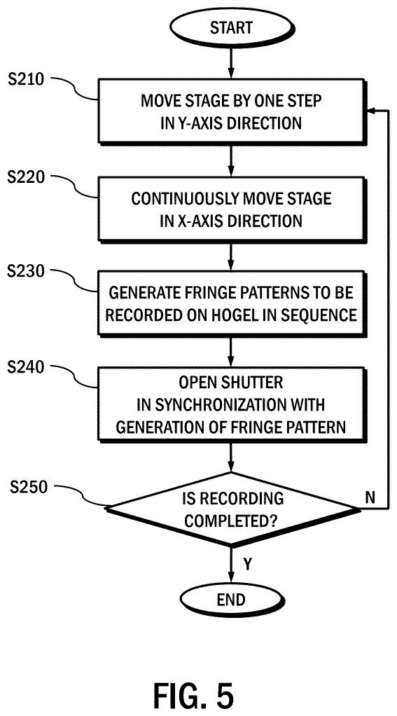

FIG. 5 is a flowchart provided to explain a continuous hologram recording method according to another embodiment of the disclosure.

To continuously record a hologram, the Y-driver 170 moves the stage 150 on which the hologram recording medium 10 is placed by one step in the Y-axis direction (S210). The X-driver 160 continuously moves the stage 150 in the X-axis direction (S220).

In the process of performing step S220, the SLM 120 may generate holographic fringe patterns to be recorded on a corresponding hogel of the hologram recording medium 10 in sequence (S230), and the shutter 130 may be opened in synchronization with generation of holographic fringe patterns at step S230 (S240).

Accordingly, hologram recording on one horizontal line of the hologram recording medium 10 is completed.

When recording is not completed, that is, there remains a horizontal line for recording on the hologram recording medium 10 (S250-N), step S210 may be resumed and hologram recording may be performed on the next line.

When recording is completed, that is, there is no horizontal line for recording on the hologram recording medium 10 (S250-Y), the hologram recording procedure is finished.

Up to now, a continuous hologram recording method has been described in detail with reference to preferred embodiments.

In the above-described embodiments, the motor for driving the stage on which the hologram recording medium, on which a hologram is to be recorded on a hogel basis, is placed in the X-axis direction is implemented not by a step motor but by a servo motor which produces low vibration when moving, so that hogel recording is continuously performed on a horizontal line without stopping the stage and a printing speed is remarkably enhanced.

It may take several days to tens of days to print a large-scale hologram. However, if time required to print a large-scale hologram can be reduced to a few hours through the continuous hologram recording method according to an embodiment, it will greatly contribute to commercialization of hologram printing.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A holographic printer comprising:
a light source configured to emit light;
a modulator configured to generate a holographic fringe pattern on a hogel basis by modulating light emitted from the light source;
a stage on which a hologram recording medium is placed, the holographic fringe pattern generated by the modulator being recorded on the hologram recording medium on a hogel basis;
a first driver configured to move a position of the stage in a first axis direction by using a motor of a first type;
a second driver configured to move the position of the stage in a second axis direction by using a motor of a second type which is different from the first type.

2. The holographic printer of claim 1, wherein the first axis direction is an X-axis direction, and the second axis direction is a Y-axis direction.

3. The holographic printer of claim 2, wherein, when the second driver moves the stage by one step in the Y-axis direction, the first driver continuously moves the stage from beginning to end in the X-axis direction.

4. The holographic printer of claim 3, wherein a length of one step by which the stage is moved by the second driver corresponds to a vertical axis length of a hogel, and
wherein a length by which the stage is continuously moved by the first driver corresponds to a length of a horizontal line of a hologram.

5. The holographic printer of claim 2, wherein the motor of the first type is a motor that produces low vibration in a moving state, and
wherein the motor of the second type is a motor that produces low vibration in a stationary state.

6. The holographic printer of claim 5, wherein the motor of the first type is a servo motor, and
wherein the motor of the second type is a step motor.

7. The holographic printer of claim 1, wherein the first driver changes a moving direction of the stage to the opposite direction on the first axis every time the position of the stage is controlled by the second driver.

8. A hologram recording method comprising:
a step of emitting light;
a step of generating a holographic fringe pattern on a hogel basis by modulating emitted light;
a step of moving a position of a stage on which a hologram recording medium, on which the generated holographic fringe pattern is to be recorded on a hogel basis, is placed in a second axis direction by using a motor of a second type; and
a step of moving the position of the stage in a first axis direction by using a motor of a first type which is different from the second type.
